(19) United States
(12) Patent Application Publication
(10) Pub. No.: US 2006/0001968 A1
(43) Pub. Date: Jan. 5, 2006

(54) Stereoscopic display device and driving method thereof

(76) Inventors: Beom-Shik Kim, Suwon-si (KR); Jang-Doo Lee, Suwon-si (KR); Hyoung-Wook Jang, Suwon-si (KR); Hui Nam, Suwon-si (KR); Myoung-Seop Song, Suwon-si (KR)

Correspondence Address: CHRISTIE, PARKER & HALE, LLP, PO BOX 7068, PASADENA, CA, 91109-7068, US

(21) Appl. No.: 11/159,541

(22) Filed: Jun. 22, 2005

(30) Foreign Application Priority Data
Jun. 30, 2004 (KR) 10-2004-0050581

(51) Int. Cl. G02B 27/26

(52) U.S. Cl. 359/465

(57) ABSTRACT

A stereoscopic display device and a driving method thereof. The stereoscopic display device includes a display unit including a first group of pixels for displaying a first image and a second group of pixels for displaying a second image, a barrier having transparent regions and non-transparent regions such that the first image and the second image are observed through the transparent regions at different points, and a data driver for providing gray scale data representing image signals to the first and second groups of pixels. The data driver provides the gray scale data to the first and second groups of pixels such that the first and second groups of pixels display an image having at least two colors during one frame.

### CROSS REFERENCE TO RELATED APPLICATION

This application claims priority to and the benefit of Korean Patent Application No. 10-2004-0050581 filed on Jun. 30, 2004, in the Korean Intellectual Property Office, the contents of which are incorporated herein by reference.

### BACKGROUND OF THE INVENTION

(a) Field of the Invention

The present invention relates to a stereoscopic display device and a driving method thereof, and more particularly to a time-divisional stereoscopic display device and a driving method thereof.

(b) Description of the Related Art

In general, factors that allow an observer to feel a stereoscopic effect include a physiological factor and an empirical factor. In the art of stereoscopic display, an observer generally feels the stereoscopic effect using binocular parallax.

Methods that allow an observer to see stereoscopic images generally include spectacles methods and non-spectacles methods.

Conventionally, representative examples of the non-spectacles methods include a lenticular method where a lenticular lens plate having cylindrical lens arrays arranged thereon in the vertical direction is provided in front of a display panel, and a barrier method where a barrier is used to separate a left eye image from a right eye image so as to attain the stereoscopic effect.

FIG. 1 is a schematic diagram illustrating a stereoscopic display device using the conventional barrier method.

As shown in FIG. 1, the stereoscopic display device includes a display panel 10 and a barrier 20. The display panel 10 includes sub-pixels 11 seen by the right eye and sub-pixels 12 seen by the left eye. In addition, the barrier 20 is arranged in front of the display panel 10 and includes transparent regions through which light passes and non-transparent regions by which light is interrupted, which are alternately arranged.

An observer sees an image displayed on the display panel 10 through the transparent regions. At this time, the left eye and the right eye of the observer see different respective regions of the display panel 10 even when they are viewed through the same transparent region. In other words, as the observer sees an image displayed in sub-pixels of adjacent regions through the left and right eyes, he can feel a stereoscopic effect.

However, in the conventional stereoscopic display device as shown in FIG. 1, since left and right images (i.e., left eye and right eye images) are respectively inputted to adjacent sub-pixels and the images of the adjacent sub-pixels are seen by the left and right eyes through the same transparent region, there is a problem in that the distance L between the display panel 10 and the barrier 20 and an observation distance D are lengthened. Accordingly, when the stereoscopic display device of FIG. 1 is applied to small-sized display devices such as mobile phones and personal digital assistants (PDAs), there is a disadvantage in that the observation distance D becomes far larger than a typical observation distance of approximately 300-400 mm at which images can be observed properly according to the optical design principles.

To overcome this problem, methods have been introduced which shorten the observation distance D by reducing the thickness of the glass of the display panel 10 and the barrier 20 or using a barrier in the form of a film for varying polarization direction of light instead of the barrier using thick glass. However, these methods have a limit to their implementation due to manufacturing difficulties.

FIG. 2 is a conventional stereoscopic display device for reducing the observation distance.

As shown in FIG. 2, the conventional stereoscopic display device attempts to overcome the problem of observation distance by separating the left image from the right image pixel by pixel, instead of sub-pixel by sub-pixel. However, when the left and right images are separated pixel by pixel, red (R), green (G) and blue (B) images are observed at different positions, causing chromatic dispersion, which results in deterioration of quality of the stereoscopic images.

### SUMMARY OF THE INVENTION

It is an aspect of the present invention to solve the problems of the conventional stereoscopic display devices, and to provide a stereoscopic display device and a driving method thereof, which is capable of securing a proper observation distance according to the optical design principles without deteriorating image quality.

In accordance with one aspect, the present invention provides a stereoscopic display device including: a display unit, a barrier, and a data driver. The display unit includes a first group of pixels for displaying a first image and a second group of pixels for displaying a second image. The barrier has transparent regions and non-transparent regions such that the first image and the second image are observed through the transparent regions at different points. The data driver provides gray scale data representing the first and second images to the first and second groups of pixels. The data driver provides the gray scale data to the first and second groups of pixels such that the first and second groups of pixels respectively display the first and second images having at least two sequentially displayed colors during one frame.

The display unit may include a liquid crystal display panel. The barrier may include a liquid crystal shutter, and the transparent regions and the non-transparent regions may be controlled such that a conversion is made between a two-dimensional image and a three-dimensional image.

In accordance with another aspect, the present invention provides a stereoscopic display device including: a display unit, a barrier, a source of light, a data driver, and a timing controller. The display unit includes a first group of pixels for displaying a first image and a second group of pixels for displaying a second image. The barrier has transparent regions and non-transparent regions such that the first image and the second image are observed through the transparent regions at different points. The source of light provides lights of at least two colors for the display unit sequentially. The data driver applies a gray scale voltage corresponding to gray scale data for the first and second images to the first and second groups of pixels. The timing controller provides a horizontal synchronization signal and the gray scale data to the data driver. The timing controller provides the gray scale data to the data driver such that the first and second groups of pixels respectively display the first and second images corresponding to at least two sequentially displayed colors during one frame.

In accordance with still another aspect, the present invention provides a method of driving a stereoscopic display device including a display unit including a first group of pixels for displaying a first image and a second group of pixels for displaying a second image, wherein one frame is divided into at least three fields including first, second and third fields. In the method, gray scale data corresponding to a first color are applied to the first and second groups of pixels in the first field; gray scale data corresponding to a second color are applied to the first and second groups of pixels in the second field; and gray scale data corresponding to a third color are applied to the first and second groups of pixels in the third field.

In accordance with still another aspect, the present invention provides a stereoscopic display device including a display panel and a barrier disposed in front of the display panel. The display panel includes a plurality of left pixels for displaying a left eye image and a plurality of right pixels for displaying a right eye image. Each pixel is adapted to sequentially display co-located red, green and blue colors. The barrier separates the left eye image from the right eye image.

### BRIEF DESCRIPTION OF THE DRAWINGS

FIG. 1 is a view illustrating a conventional stereoscopic display device;

FIG. 2 is a view illustrating another conventional stereoscopic display device;

FIG. 3 is a schematic block diagram illustrating the configuration of a stereoscopic display device according to an exemplary embodiment of the present invention;

FIG. 4 is a view illustrating an image displayed in a first field in the stereoscopic display device according to the exemplary embodiment of the present invention;

FIG. 5 is a view illustrating an image displayed in a second field in the stereoscopic display device according to the exemplary embodiment of the present invention;

FIG. 6 is a view illustrating an image displayed in a third field in the stereoscopic display device according to the exemplary embodiment of the present invention; and

FIG. 7 is a view illustrating an image displayed during one frame in the stereoscopic display device according to the exemplary embodiment of the present invention.

### DETAILED DESCRIPTION

In the following detailed description, only certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive. There may be parts shown in the drawings, or parts not shown in the drawings, that are not discussed in the specification as they are not essential to a complete understanding of the invention. Like reference numerals designate like elements.

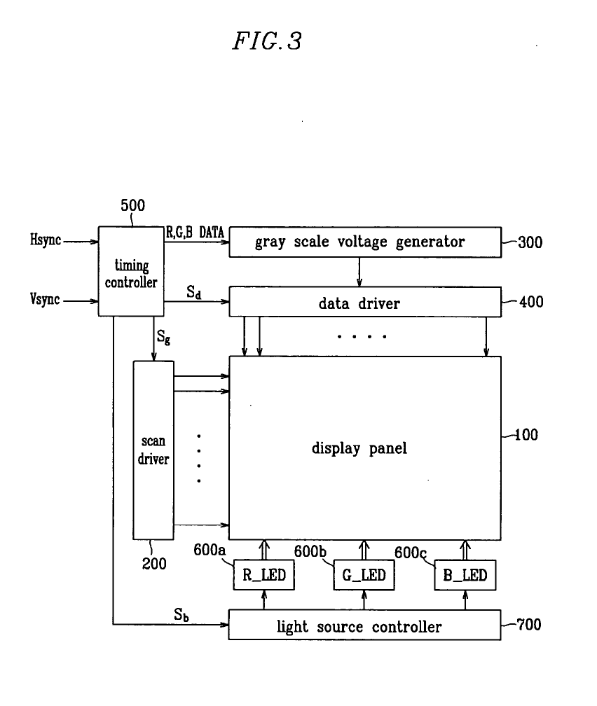

FIG. 3 is a schematic view illustrating the configuration of a stereoscopic display device according to an exemplary embodiment of the present invention.

Referring to FIG. 3, the stereoscopic display device according to the exemplary embodiment of the present invention includes a display panel 100, a scan driver 200, a gray scale voltage generator 300, a data driver 400, a timing controller 500, light emitting diodes 600a, 600b and 600c (R_LED, G_LED and B_LED) for emitting red (R), green (G) and blue (B) lights, respectively, and a light source controller 700.

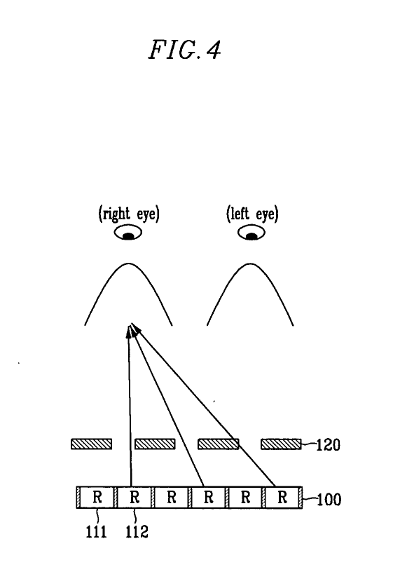

While not shown in detail in FIG. 3, the display panel 100 includes a plurality of scan lines for transmitting selection signals, a plurality of data lines formed crossing and isolated from the plurality of scan lines for transmitting gray scale voltage corresponding to gray scale data, and a plurality of pixel circuits formed in pixel regions defined by the plurality of scan lines and the plurality of data lines. Each pixel circuit includes a thin film transistor having a gate electrode and a source electrode coupled to a corresponding one of the plurality of scan lines and a corresponding one of the plurality of data line, respectively, and a pixel capacitor and a storage capacitor, which are coupled to a drain electrode of the thin film transistor. The display panel 100, for example, may be a liquid crystal display (LCD) panel including liquid crystal disposed between two substrates, and have a structure and operation known to those skilled in the art. The pixels of the display panel 100, for example, are illustrated in FIGS. 4-7, which also illustrate a barrier placed in front of the display panel.

The scan driver 200 applies the selection signals to the scan lines sequentially to turn on the thin film transistor having the gate electrode coupled to the scan lines to which the selection signals are applied.

The gray scale voltage generator 300 generates the gray scale voltage corresponding to the gray scale data and supplies it to the data driver 400. The data driver 400 applies the gray scale voltage outputted from the gray scale voltage generator 300 to the data lines.

The timing controller 500 receives the gray scale data R, G, B DATA, a horizontal synchronization signal Hsync, and a vertical synchronization signal Vsync externally or from a graphic controller (not shown), supplies required control signals Sg, Sd and Sb to the scan driver 200, the data driver 400 and the light source controller 700, respectively, and supplies the gray scale data R, G, B DATA to the gray scale voltage generator 300. The control signal Sd provided to the data driver 400 may be generated using the horizontal synchronization signal Hsync and/or include Hsync, and may also be referred to as a horizontal synchronization signal herein. Also, the gray scale voltage generator 300 and the data driver 400 may together be referred to as a data driver herein.

The light emitting diodes 600a, 600b and 600c respectively emit lights corresponding to red (R), green (G) and blue (B) to the display panel 100 and the light source controller 700 controls lighting time of the light emitting diodes 600a, 600b and 600c. In this embodiment, a point in time when the data driver 400 applies the gray scale data to the data lines and a point in time when the light source controller 700 lights the red (R), green (G) and blue (B) light emitting diodes can be synchronized with each other by the control signals supplied by the timing controller 500.

According to the exemplary embodiment of the present invention, a plurality of pixels formed in the display panel 100 are not divided into sub-pixels of red (R), green (G) and blue (B) colors, but rather one pixel is used to display the red (R), green (G) and blue (B) colors in a time divisional manner.

In detail, the timing controller 500 divides one frame into at least three fields and controls pixels for the left and right eyes formed in the display panel 100 to display the red (R) color in a first field, the green (G) color in a second field, and the blue (B) color in a third field.

Accordingly, since the left and right images can be displayed pixel by pixel, an observation distance can be fixed at a proper level, and observation points of the red (R), green (G) and blue (B) images are substantially the same, allowing color dispersion to be prevented.

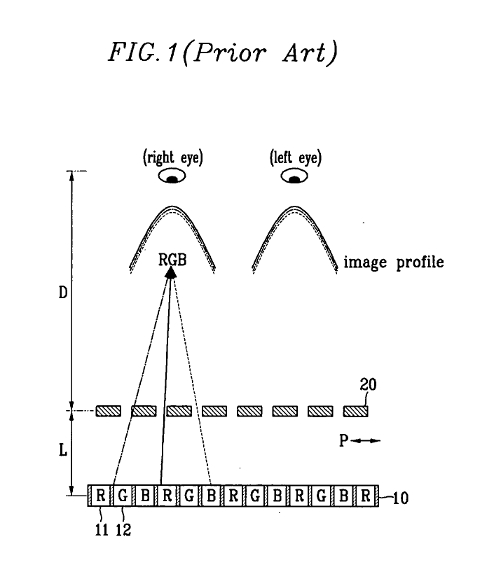

In more detail, when the stereoscopic display device implemented based on the barrier method is applied to small-sized terminals such as mobile phones, a distance between the barrier and the pixels should be minimized such that the barrier is in close contact with the display panel in order to secure a proper observation distance of approximately 300 mm to 400 mm. However, since the barrier and the display panel use glass and have respective fixed thicknesses, it is difficult to reduce the distance between the barrier and the pixels. Thus, with the distance between the barrier and the pixels fixed, the observation distance and the pitch of pixels are inversely proportional to each other. In addition, in the case where the left and right images are displayed sub-pixel by sub-pixel, as shown in FIG. 1, the observation distance is very large as compared to the proper observation distance of approximately 300 mm to 400 mm.

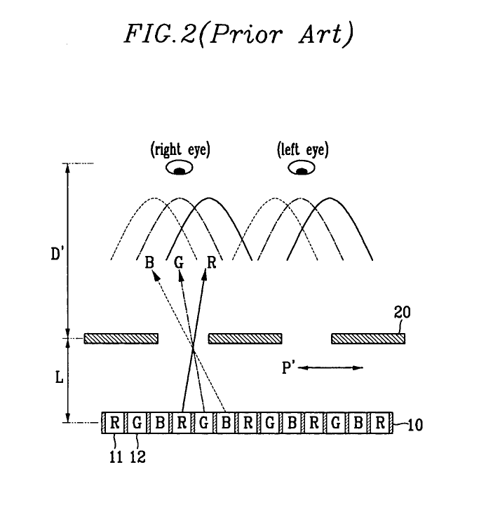

However, in the case where the left and right images are displayed pixel by pixel (one pixel includes three sub-pixels, as shown in FIG. 2), the image quality is deteriorated due to color dispersion, as described above, although the pitch of pixels is lengthened and hence the observation distance is shortened.

In this embodiment, accordingly, without dividing the sub-pixels of the red (R), green (G) and blue (B) colors spatially, only one pixel is used to display the red (R), green (G) and blue (B) colors in the time divisional manner. This allows the proper observation distance to be secured without any color dispersion.

Hereinafter, a driving method of the stereoscopic display device according to the exemplary embodiment of the present invention will be described with reference to FIGS. 4 to 7. The driving method will be described, for example, in reference to the case where one frame is divided into three fields.

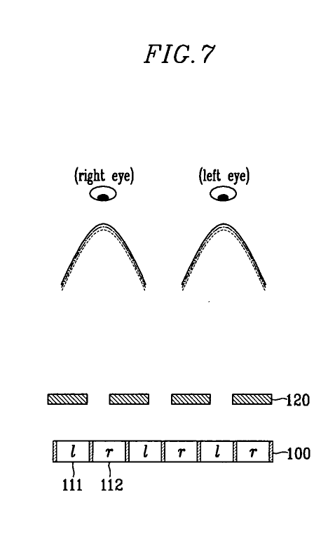

FIGS. 4 to 6 are views illustrating an image displayed in first, second and third fields, respectively, in the stereoscopic display device according to the exemplary embodiment of the present invention, and FIG. 7 is a view illustrating an image displayed during one frame in the stereoscopic display device.

Referring to FIGS. 4 to 7, the display panel 100 according to the exemplary embodiment of the present invention receives the gray scale data R, G, B DATA as three-dimensional image signals from the timing controller 500, and then, for example, displays the left image through odd-numbered pixels 111 and the right image through even-numbered pixels 112. A barrier 120 is placed in front of the pixels 111 and 112 of the display panel 100 as can be seen in FIGS. 4 to 7.

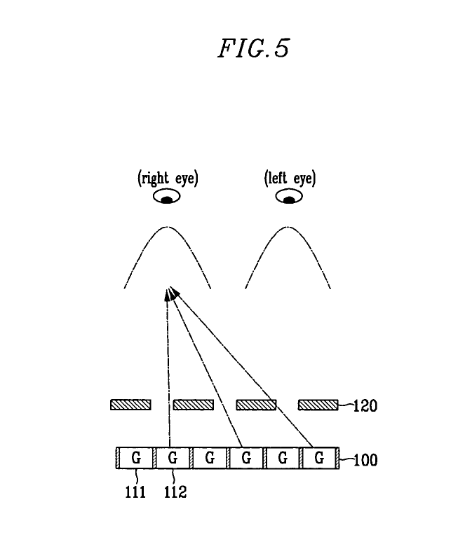

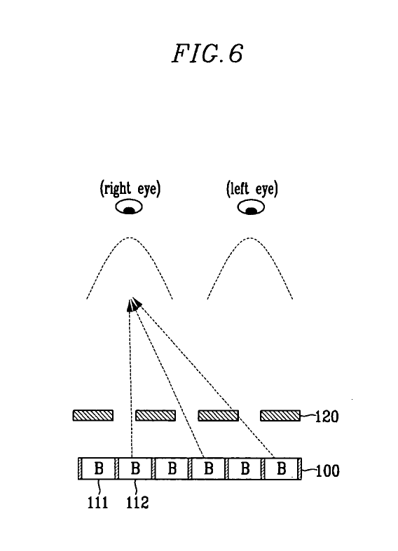

In addition, a gray scale voltage corresponding to the red (R) color is applied to pixels for the left eye and pixels for the right eye in the first field, as shown in FIG. 4; a gray scale voltage corresponding to the green (G) color is applied to the pixels for the left eye and the pixels for the right eye in the second field, as shown in FIG. 5; and a gray scale voltage corresponding to the blue (B) color is applied to the pixels for the left eye and the pixels for the right eye in the third field, as shown in FIG. 6.

In other words, as the red (R), green (G) and blue (B) colors are displayed using only one pixel in the time divisional manner without dividing the sub-pixels of the red (R), green (G) and blue (B) colors spatially, light emitted from one pixel converges on one point at a designed observation distance, alleviating the color dispersion, as shown in FIG. 7, In addition, since the images are separated pixel by pixel, the observation distance can be fixed at a proper level.

For example, while sub-pixels having the red (R), green (G) and blue (B) colors are concurrently turned on at a frequency of 60 Hz to form images in the conventional stereoscopic display devices, the red (R), green (G) and blue (B) images are sequentially displayed in one pixel at a frequency of 180 Hz to thereby complete one frame at a frequency of 60 Hz in the stereoscopic display device according to the exemplary embodiment of the present invention.

Then, the red (R), green (G) and blue (B) colors are jointly seen due to an afterimage effect of human eyes and are seen at the same position during one frame, which results in realization of a stereoscopic display device without any color dispersion.

In addition, the pitch of one pixel in the stereoscopic display device according to the exemplary embodiment of the present invention is three times the pitch of a sub-field in the conventional typical stereoscopic display device having the same resolution and size as the stereoscopic display device according to the exemplary embodiment of the present invention. Accordingly, the stereoscopic display device according to the exemplary embodiment of the present invention can accomplish the effect that the observation distance is shortened and the left and right images are separated pixel by pixel.

In accordance with the exemplary embodiment of the present invention, the barrier 120 having transparent regions and non-transparent regions provided in front of the display panel 100 can be formed by a liquid crystal shutter. The liquid crystal shutter uses molecular arrangement of liquid crystal to perform transmission or shutting of lights corresponding to images. In detail, the molecular arrangement of the liquid crystal is changed depending on an applied voltage. Such a change of the molecular arrangement of the liquid crystal leads to optical modulations such as birefringence, optical rotatory, dichroism, and light scattering. Such optical modulations are used to perform the transmission or shutting of the images. In other words, the liquid crystal shutter includes a left eye image transparent region and a right eye image transparent region, which are arranged alternately and are opened or shut depending on a received driving signal. Accordingly, an observer observes a left eye image passing through the left eye image transparent region with his left eye and a right eye image passing through the right eye image transparent region with his right eye.

In this way, when the barrier is formed by the liquid crystal shutter, the stereoscopic display device which is capable of representing two-dimensional stereoscopic images as well as three-dimensional stereoscopic images by controlling the molecular arrangement of the liquid crystal can be provided.

As is apparent from the above description, when the stereoscopic display device according to the exemplary embodiment of the present invention is applied to the small-sized mobile terminals, an image conversion can be made between a two-dimensional image and a three-dimensional image with a proper observation distance and without any color dispersion.

Although the case where the barrier has two viewing angles of the left and right eye images has been described above in reference to the exemplary embodiment of the present invention, the present invention is applicable to the case where the barrier has three or more viewing angles operating such that three or more transparent regions are opened sequentially in a time divisional manner.

In addition, although FIGS. 4 to 6 show that the pixels for the left eye images and the pixels for the right eye images display images having the same color in one field, alternatively, the pixels for the left eye images and the pixels for the right eye images can display images having different colors in the same field.

While this invention has been described in connection with certain exemplary embodiments, it is to be understood that the invention is not limited to the disclosed embodiments, but, on the contrary, is intended to cover various modifications and equivalent arrangements included within the spirit and scope of the appended claims.

What is claimed is:

1. A stereoscopic display device comprising:
a display unit including a first group of pixels for displaying a first image and a second group of pixels for displaying a second image;
a barrier having transparent regions and non-transparent regions such that the first image and the second image are observed through the transparent regions at different points; and
a data driver for providing gray scale data representing the first and second images to the first and second groups of pixels,
wherein the data driver provides the gray scale data to the first and second groups of pixels such that the first and second groups of pixels respectively display the first and second images having at least two sequentially displayed colors during one frame.

2. The stereoscopic display device of claim 1, wherein the display unit comprises a liquid crystal display panel.

3. The stereoscopic display device of claim 1, wherein the barrier comprises a liquid crystal shutter, and the transparent regions and the non-transparent regions are controlled such that a conversion is made between a two-dimensional image and a three-dimensional image.

4. The stereoscopic display device of claim 1, wherein an observation distance of the first image and the second image is approximately 300 mm to 400 mm.

5. The stereoscopic display device of claim 1, wherein the data driver transmits the gray scale data corresponding to red, green and blue colors to the first and second groups of pixels sequentially during one frame.

6. The stereoscopic display device of claim 1, wherein the first image is a left eye image and the second image is a right eye image.

7. A stereoscopic display device comprising:
a display unit including a first group of pixels for displaying a first image and a second group of pixels for displaying a second image;
a barrier having transparent regions and non-transparent regions such that the first image and the second image are observed through the transparent regions at different points;
a source of light for providing lights of at least two colors for the display unit sequentially;
a data driver for applying a gray scale voltage corresponding to gray scale data for the first and second images to the first and second groups of pixels; and
a timing controller for providing a horizontal synchronization signal and the gray scale data to the data driver,
wherein the timing controller provides the gray scale data to the data driver such that the first and second groups of pixels respectively display the first and second images corresponding to at least two sequentially displayed colors during one frame.

8. The stereoscopic display device of claim 7, wherein the display unit comprises a liquid crystal display panel.

9. The stereoscopic display device of claim 7, wherein the barrier comprises a liquid crystal shutter, and the transparent regions and the non-transparent regions are controlled by controlling a molecular arrangement of liquid crystal contained in the liquid crystal shutter.

10. The stereoscopic display device of claim 7, wherein the data driver applies the gray scale data corresponding to red, green and blue colors to the first and second groups of pixels sequentially during one frame.

11. A method of driving a stereoscopic display device including a display unit including a first group of pixels for displaying a first image and a second group of pixels for displaying a second image, wherein one frame is divided into at least three fields including first, second and third fields, the method comprising:
applying gray scale data corresponding to a first color to the first and second groups of pixels in the first field;
applying gray scale data corresponding to a second color to the first and second groups of pixels in the second field; and
applying gray scale data corresponding to a third color to the first and second groups of pixels in the third field.

12. The method of claim 11, wherein the display unit comprises a liquid crystal display panel, and the gray scale data is a voltage having a predetermined range.

13. The method of claim 11, further comprising providing lights of the first, second and third colors to the display unit sequentially during the first, second and third fields, respectively.

14. A stereoscopic display device comprising:
a display panel comprising a plurality of left pixels for displaying a left eye image and a plurality of right pixels for displaying a right eye image, each pixel being adapted to sequentially display co-located red, green and blue colors; and
a barrier disposed in front of the display panel for separating the left eye image from the right image.

15. The stereoscopic display device of claim 14, wherein the left and right eye images are displayed during a frame comprising a plurality of fields, and wherein all of the pixels display the red color during a first one of the fields, the blue color during a second one of the fields, and the green color during a third one of the fields.

16. The stereoscopic display device of claim 14, wherein the left and right eye images are displayed during a frame comprising a plurality of fields, and wherein the left pixels display one of the colors that is different from another one of the colors displayed by the right pixels in one or more of the fields.

17. The stereoscopic display device of claim 14, wherein the barrier comprises a plurality of transparent regions and a plurality of non-transparent regions that are used to separate the left eye image from the right eye image.

18. The stereoscopic display device of claim 14, wherein an observation distance of the first image and the second image is approximately 300 mm to 400 mm.

19. The stereoscopic display device of claim 14, further comprising a data driver for providing gray scale data corresponding to the first and second images to the display panel.

20. The stereoscopic display device of claim 19, further comprising a timing controller for providing a horizontal synchronization signal and the gray scale data to the data driver.
